(19) United States
(12) Patent Application Publication
(10) Pub. No.: US 2021/0142298 A1
(43) Pub. Date: May 13, 2021

(54) PROXIMITY-BASED EXCHANGE BETWEEN PHYSICAL CURRENCY AND DIGITAL ACCOUNTS RELATED TO CRYPTOCURRENCY

(71) Applicant: Netclearance Systems, Inc., Escondido, CA (US)

(72) Inventor: David Fernandez, Escondido, CA (US)

(73) Assignee: Netclearance Systems, Inc., Escondido, CA (US)

(21) Appl. No.: 17/093,532

(22) Filed: Nov. 9, 2020

Related U.S. Application Data
(60) Provisional application No. 62/933,315, filed on Nov. 8, 2019.

(51) Int. Cl. G06Q 20/06; G06Q 20/38; G06Q 20/40; G06Q 20/36; G06Q 20/32; G07F 7/04

(52) U.S. Cl. CPC G06Q 20/065; G06Q 20/38215; G06Q 20/401; G06Q 2220/00; G06Q 20/3224; G07F 7/04; G06Q 20/36

(57) ABSTRACT

A retrofit interface module (RIM) described herein may allow legacy cash terminals to perform cryptocurrency-based transactions. The RIM may be installed at existing cash terminals such as vending machines, parking kiosks, ticket booths, etc. The RIM may allow the legacy cash terminals to interact with user devices such as smartphone across one or more wireless communication channels in order to perform cryptocurrency-based transactions. Such transactions may include cryptocurrency payments to cash terminals and cash deposits to cryptocurrency accounts or coins via the RIM and an associated cash terminal.

### CROSS-REFERENCE TO RELATED APPLICATIONS

This application claims priority to U.S. Provisional Patent Application Ser. No. 62/933,315, filed on Nov. 8, 2019. U.S. Pat. No. 9,811,846 B2, issued on Nov. 7, 2017, U.S. Pat. No. 9,933,265 B2, issued on Apr. 3, 2018, U.S. Pat. No. 9,928,536 B2, issued on Mar. 27, 2018, U.S. Pat. No. 10,586,251 B2, issued on Mar. 10, 2020, U.S. Patent publication number 2015/0206096 A1, published on Jul. 23, 2015, U.S. Patent Publication number 2017/0178104 A1, published on Jun. 22, 2017, and U.S. Patent publication number 2018/0150819 A1, published on May 31, 2018, are herein incorporated by reference.

### BACKGROUND

Many people utilize digital wallets or accounts associated with cryptocurrencies. Legacy cash-based devices or systems such as vending machines, parking meters, etc. are ubiquitous and require physical currency.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates an example overview of one or more embodiments described herein, in which a cryptocurrency payment is applied at a cash terminal;

FIG. 2 illustrates an example overview of one or more embodiments described herein, in which a cash deposit is applied to a cryptocurrency account;

FIG. 3A illustrates an exemplary graphical user interface (GUI) of one or more embodiments described herein, in which a cryptocurrency payment is applied at a cash terminal;

FIG. 3B illustrates an exemplary GUI of one or more embodiments described herein, in which a cash deposit is applied to a cryptocurrency account;

FIG. 4 illustrates a schematic block diagram of an exemplary retrofit interface module of one or more embodiments described herein;

FIG. 5 illustrates a schematic block diagram of a portion of a cash terminal of one or more embodiments described herein;

FIG. 6 illustrates a schematic block diagram of a portion of an upgraded cash terminal of one or more embodiments described herein;

FIG. 7 illustrates a message flow diagram associated with various exemplary transactions performed by one or more embodiments described herein;

FIG. 8 illustrates a flow chart of an exemplary process that implements a digital wallet payment at a cash terminal;

FIG. 9 illustrates a flow chart of an exemplary process that implements a cash deposit to a digital wallet at a cash terminal;

FIG. 10 illustrates a flow chart of an exemplary process that implements a digital wallet payment at a cash terminal via a user device;

FIG. 11 illustrates a flow chart of an exemplary process that implements a cash deposit from a cash terminal to a digital wallet via a user device;

FIG. 12 illustrates a flow chart of an exemplary process that implements a digital wallet payment at a cash terminal via a digital currency manager;

FIG. 13 illustrates a flow chart of an exemplary process that implements a cash deposit from a cash terminal to a digital wallet via a digital currency manager; and

FIG. 14 illustrates a schematic block diagram of one or more exemplary devices used to implement various embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide exchange between physical and digital currency.

Many machines and systems accept physical currency or cash. Such cash-based systems or devices include parking kiosks, vending machines, ticket vending machines, tollbooths, etc. Digital cash or currency-based transactions are only available for online systems or user devices that are connected to the Internet. As more digital cash methods become available there is a need to easily retrofit millions of machines that today accept physical currency (e.g., coins and/or notes) with a way to accept digital cash stored in a mobile application on a smartphone or a physical token.

A retrofit interface module (RIM) of some embodiments may provide ways to transmit and receive digital cash between a cash accepting machine (or “cash terminal”) such as a vending machine, payment kiosk, etc., and a user device or token that stores digital currency (or otherwise processes digital currency transactions). Digital currency may include cryptocurrencies, alternative cryptocurrencies, tokens, and/or other types of digital assets. Throughout this disclosure, use of the terms “cryptocurrency”, “digital wallet”, “token”, “digital asset”, “alternative cryptocurrencies”, etc. shall refer to any and all types of representations of value or wealth that may be stored in a digital format. Such formats may include, for instance, blockchain-type cryptocurrencies where the validity of each cryptocurrency “coin” (or other unit or indicator of value, represented as a data string) is able to be evaluated based on a set of blocks linked and secured using cryptography. Each block may typically include a hash pointer as a link to a previous block, a timestamp, and transaction data.

The RIM may be installed inside cash terminals and may emulate deposit or withdrawal of physical currency in order to implement various transactions at the cash terminals. The RIM may be able to implement various digital currency transactions, such as deposit, withdrawal, payment, etc. via a connected user device, such as a smartphone, and/or other appropriate resources. For example, a bill or coin acceptor or validator of the cash terminal may be used to deposit money into the cash terminal, the cash terminal may count the money, and the RIM may generate a digital claim or check representation that can be transmitted to the user device via a secure connection (e.g., Bluetooth). In a similar way, the user device may send digital currency to the cash terminal via the secure connection and the RIM may convert the digital currency to electrical signals or messages that emulate receipt of physical cash at the cash terminal.

There are various benefits to upgrading cash terminals with the RIM of some embodiments. For example, the cash terminal is not required to be connected to the internet as the user device may serve as a network gateway to send and receive data via various networks (e.g., cellular networks, wireless networks, the Internet, etc.). As another example, no cashier or other person is needed to receive, distribute, count, and/or otherwise process physical currency as the cash terminal already has the capability to do that. The RIM permits payment of an exact amount, thus speeding up transactions that would otherwise require change to be provided. The RIM may allow transactions to occur even when the cash terminal does not have sufficient resources for a physical cash transaction (e.g., insufficient change to process a transaction where a user has only bills or notes). In addition, the RIM reduces problems associated with physical cash collection (such as theft) because a machine operator is not required to extract physical cash from the cash terminal (or may collect cash less often) if the transactions are performed in a digital format.

FIG. 1 illustrates an example overview of one or more embodiments described herein, in which a cryptocurrency payment is applied using a RIM 100 at a cash terminal 110. A cash terminal 110 may be a machine or device that is able to accept and/or dispense physical currency such as notes and/or coins. Cash terminals 110 may include other payment collection or dispensation features than physical currency, such as a credit card reader, token slot, ticket reader, etc. Examples of such cash terminals 110 include, for instance, automated teller machines (ATMs), vending machines, parking payment terminals, ticket machines, tollbooths, and/or other appropriate devices, systems, or components that are able to accept or dispense cash.

In the context of upgrading existing or legacy cash terminals 110 using RIM 100, the cash terminals 110 do not have native wireless communication capabilities and/or other network communication capabilities, such as an Ethernet or other wired connection. As such, the RIM 100 may provide wireless and/or network connectivity to upgrade such legacy cash terminals 110, and any references to “cash terminals” 110 throughout this disclosure shall be understood to refer to legacy cash terminals 110 that do not include wireless or network connectivity.

As shown, each cash terminal 110 may include a currency module 120. The currency module 120 may include an interface between a cash collection and/or dispensation element and a payment processing, dispensation element, and/or other processor, controller, or element. For instance, a soda vending machine may include a coin slot and a bill scanner that may be able to receive currency. Such elements may be coupled to a controller or other element that is able to determine when a designated amount of money has been submitted and a product may be dispensed (e.g., by enabling a number of selection buttons associated with different available types of soda). As another example, a parking payment terminal may include a bill scanner and a receipt printer that provides a payment record when data received from the bill scanner indicates that a designated parking fee has been paid. RIM 100 may include one or more terminal interfaces such that a RIM 100 may be included between the cash collection element and the payment processing element. In this way, RIM 100 may emulate cash payments based on cryptocurrency payments and/or process other transactions involving physical currency and cryptocurrency. Such terminal interfaces will be described in more detail in reference to FIG. 5, FIG. 6, and FIG. 7 below.

As shown in FIG. 1, RIM 100 may communicate with user device 130. User device 130 may be a device or component such as a smartphone, tablet, smartwatch or other wearable device, a cryptocurrency device that is able to store and/or process cryptocurrency information, and/or other appropriate devices that are able to communicate across a local wireless connection or channel, such as Bluetooth, Wi-Fi, etc.

User device 130 may communicate with one or more network resources, such as digital currency manager 140. Such resources may be accessible over various networks, such as Wi-Fi, cellular, the Internet, etc.

Digital currency manager 140 may be an electronic device, such as a server or storage, that is associated with a resource such as a digital wallet or other cryptocurrency management resource or account that is able to generate, validate, and/or otherwise interact with cryptocurrency data and/or transactions. Digital currency manager 140 may, for instance, calculate account balance, apply deposits, process payments or withdrawals, and/or otherwise process transactions or data associated with management of cryptocurrency. Digital currency manager 140 may be accessible via an application programming interface (API) or other similar interface. Digital currency manager 140 may be associated with, or be able to interact with, various financial resources, such as cryptocurrency wallets, online banks or other financial institutions, cash terminal management or deployment entities, and/or other appropriate resources that may be associated with cryptocurrency or cash transactions.

Digital currency manager 140 may be a dedicated device associated with a set of deployed RIMs 100. For instance, an operator of a vending machine route may install RIMs 100 at various legacy machines and manage payments or other transactions via the digital currency manager 140.

In some embodiments, digital currency manager 140 may be associated with, or be able to interact with, payment processing and/or verification resources, and/or other external resources. For instance, user device 130 may submit a deposit token, such as a blockchain string associated with one or more coins, to digital currency manager 140, which may evaluate and confirm the validity of the deposit token. If the deposit token is determined to be valid, the digital currency manager 140 may generate a digitally signed receipt, proof of deposit, or other appropriate certification that may be returned to the user device 130.

As one example use case, cash terminal 110 may be associated with a soda vending machine that collects coins or bills and dispenses cans of soft drinks. RIM 100 may be installed at the vending machine such that cryptocurrency payments are able to be provided by RIM 100 to currency module 120 by emulating signals generated by the coin and/or bill collector(s). RIM 100 may be able to interact with cash terminal 110 in various other ways in some embodiments, For instance, RIM 100 may interface with a dispensation module, or various physical switches or other appropriate features associated with stored can positions, such that available inventory may be determine by RIM 100.

As shown, RIM 100 may establish (at 150) a connection to a user device 130. Such a connection may include a wireless communication channel, such as Bluetooth or Wi-Fi. In some embodiments, information related to cash terminal 110 may be received over the connection. Such information may include, for instance, price information, accepted payment types, product information, inventory information, etc.

RIM 100 may be associated with various connection parameters that may be configured in various appropriate ways. For instance, RIM 100 may generate a beacon signal using a radio transmitter (e.g., a Bluetooth transmitter, Wi-Fi transmitter, etc.). The transmitter may be configured such that the beacon signal is only detectable within a specified range (e.g., within three feet, within six feet, etc.). The beacon signal may include identifying information associated with RIM 100 (e.g., a unique serial number) and/or cash terminal 110 (e.g., a descriptor of the vending machine, such as “Brand X Machine”).

User device 130 may receive the beacon signal and send a response. The response may include information, such as user device 130 identifying information and/or user identifying information (e.g., serial number, username, etc.), that may be validated by RIM 100. Such validation may include communication between RIM 100 and a resource such as digital currency manager 140 via user device 130. For instance, the unique identifier of the RIM 100 may be sent, along with a username or account number, password, and/or other appropriate information to the digital currency manager 140 for validation. The digital currency manager 140 may interact with various other resources to validate the provided information. If the information is valid, a token or key may be returned to RIM 100, which may be validated by RIM 100. In some cases, the beacon signal may be used to initiate a standard wireless connection (e.g., a Bluetooth connection) without any additional validation of user or device identity.

The user device 130 may receive a request to make a cryptocurrency payment to the cash terminal 110. Such a request may be received via a user interface (UI), such as a graphical user interface (GUI), and/or other appropriate resource, such as a web page or form. Example GUIs will be described in reference to FIG. 3A and FIG. 3B below. Continuing the soda vending machine example, a user may read a sign indicating each can of soda costs two dollars and may enter a payment amount of two dollars to be applied at the vending machine.

The user device 130 may receive (at 160) a payment request to the digital currency manager 140. The payment request may include information such as the serial number or other identifier associated with the RIM 100. Such information may be used to validate requests received via user devices 130.

The digital currency manager 140 may evaluate the request and generate a validation token if the request is determined to be valid or generate a denial if the request is determined to be invalid. Digital currency manager 140 may send (at 170) the validation or denial to the user device 130. A validation message or token may include an updated or modified cryptocurrency data string. For example, if the digital currency manager 140 is associated with a digital wallet account, user credentials such as an account number or username may be compared to a lookup table listing active accounts. The requested payment amount may be compared to a current available balance and validated if the available balance exceeds the requested payment.

As another validation example, each RIM 100 may be associated with a specified geographic location, as specified by a lookup table or other resource available to digital currency manager 140. Location information (e.g., global positioning system (GPS) information) and the RIM identifier may be provided by the user device 130 in a payment request message to the digital currency manager 140. If the provided location is not within a specified range of the location associated with the RIM 100, a transaction may be denied by the digital currency manager 140.

RIM 100 and digital currency manager 140 may digitally sign each transaction using, for example, public key infrastructure (PKI) and/or other appropriate resources such that transactions may be verified and secure even with intermediary participation (e.g., by user device 130).

The RIM 100 may receive (at 180) the validation from the user device 130 and emulate a cash payment to cash terminal 110. For instance, continuing the soda vending machine example, RIM 100 may send signals to currency module 120 emulating an indication that two one-dollar bills were received by a note scanner associated with cash terminal 110. Based on the emulated two-dollar cash payment signals, cash terminal 110 may authorize or enable dispensation of one can of soda.

In some embodiments, cryptocurrency coin data strings may be stored at the user device 130 and may be received (at 180) by RIM 100 without interaction between user device 130 and digital currency manager 140. In such cases, RIM 100 may be able to validate various types of cryptocurrency coin data strings and apply payments based on the received data. RIM 100 may be able to perform various evaluation or validation algorithms, as appropriate. In addition, RIM 100 may be able to generate or otherwise provide “change” in the form of cryptocurrency data strings received during previous transactions. RIM 100 may be able to store various exchange rates or other data that may indicate relative value of various cryptocurrencies. Such data may be able to be updated at regular intervals. For instance, a technician may utilize a wired connection to RIM 100 to retrieve stored cryptocurrency coins, add additional cryptocurrency coins to storage, update exchange rates, update inventories or available selections, etc.

FIG. 2 illustrates an example overview of one or more embodiments described herein, in which a cash deposit is applied to a digital wallet or other cryptocurrency account. RIM 100 may establish a connection to user device 130 in a similar manner to that described above.

Currency module 120 may receive (at 210) a cash deposit, such as a number of bills and/or coins. RIM 100 may receive evaluate signals received from currency module 120 to determine (at 220) an amount of cash deposited at cash terminal 110 and send the amount to user device 130. For example, five twenty-dollar bills may be received, for a total value of one hundred dollars. In some embodiments, a bill validator or other cash receipt hardware of cash terminal 110 may include a scanner or camera that may be able to retrieve information related to deposited notes (e.g., a serial number). Such information may be stored or otherwise associated with cash terminal transactions (including cryptocurrency transactions) for analysis, verification, and/or authentication.

User device 130 may provide a GUI, or other appropriate resource, that may be used to specify one or more destinations for the deposited cash (e.g., one or more cryptocurrency account numbers and/or digital wallet usernames). Digital currency manager 140 may receive (at 230) a deposit request, including, for instance, a list of account numbers and associated amounts from the user device 130. In this example, the request may indicate one hundred dollars is to be deposited to a specified account. The deposit request may include various elements that may be used to validate the request. For instance, a serial number of the RIM 100 may be included in the request.

Digital currency manager 140 may receive and evaluate the deposit request. Such evaluation may include, for instance, comparison of account numbers, usernames, passwords, etc. to various lookup tables or other resources indicating validity of such data. Various other criteria may be established and/or implemented by digital currency manager 140, such as deposit limits associated with a user or account, cash terminal type, cryptocurrency type, etc. In addition, data associated with RIM 100, such as a unique identifier, may be evaluated such as by retrieving and analyzing historical information related to the RIM 100.

If the deposit request is determined to be valid, the digital currency manager 140 may send (at 240) a validation message to the user device 130. The validation message may include a digital signature, a key, or other secure indicator that is able to be evaluated and/or verified by the user device 130 and/or the RIM 100. In some embodiments, such validation messages may be stored by the RIM 100 for analysis by other resources. Such information may include, for instance, a RIM identifier, user device identifier, digital currency manager identifier, and/or other appropriate information.

RIM 100 may receive (at 250) a validation message from the user device 130 and confirm the deposit, or receive a denial message and reject the deposit. A validation or confirmation message may include a digitally signed deposit receipt to be stored at RIM 100. In some cases, the validation or confirmation message may include an updated cryptocurrency data string. RIM 100 may send signals to currency module 120 indicating that deposited cash is to be returned if a denial message is received.

One of ordinary skill in the art will recognize that RIM 100 and/or other components described above may be implemented in various different ways without departing from the scope of the disclosure. For instance, RIM 100 may interact with various other elements of cash terminal 110 than the currency module 120. Such other elements may include, for instance, a power supply, inventory modules, dispensation modules, selection modules, etc.

FIG. 3A illustrates an exemplary GUI 300 of one or more embodiments described herein, in which a cryptocurrency payment is applied at a cash terminal 110. FIG. 3B illustrates an exemplary GUI 350 of one or more embodiments described herein, in which a cash deposit is applied to a digital wallet or other cryptocurrency resource. Some embodiments may utilize various web browsers, user device applications, and/or other appropriate resources to implement elements such as GUI 300 or GUI 350.

GUI 300 and GUI 350 may include various elements, such as text or graphic indicators 310, selection or entry features 320, submission elements or buttons 330, and/or other appropriate elements.

In this example, GUI 300 may be associated with a purchase. GUI 300 may receive data related to the transaction, such as type (“purchase”), selections (indicated as positions A-4 and B-6), payment source, and/or amount. In this example, a payment amount may be calculated based on price data associated with the selected options. Alternatively, the payment amount may be entered and applied to any available items or selection options. The GUI 300 may receive such transaction information that may be authenticated or otherwise verified before a final selection is able to be made. If the submit button 330 is selected, the payment may be processed, such as by emulating a cash payment to the vending machine. Such payment emulation may allow the user to make selections up to the payment amount.

In this example, GUI 350 may be associated with a cash deposit to a cryptocurrency account. GUI 350 may receive data related to the transaction, such as type (“deposit”), an amount (as determined by cash terminal 110), a destination account, and/or other appropriate data.

GUI 300, GUI 350, and/or other similar GUIs may include various feedback elements, such as indication of status (“processing”, “cash available to deposit”, “payment request sent”, “confirmation received”, “make selection”, “insufficient balance”, etc.).

Various other GUIs may be associated with various other operations or actions associated with RIM 100 and/or digital currency manager 140. For instance, a technician device may be able to connect to RIM 100 via a physical connector (e.g., a universal serial bus (USB) connector) in order to collect deposited cryptocurrency (e.g., by retrieving cryptocurrency coins or other data strings), add cryptocurrency tokens for deposit based on received cash, update exchange rates, modify beacon signal attributes, and/or otherwise update operation of RIM 100 and/or digital currency manager 140.

FIG. 4 illustrates a schematic block diagram of an exemplary RIM 100 of one or more embodiments described herein. As shown, RIM 100 may include a terminal interface 410, one or more processors 420, storage or memory 430, UI 440, security module 450, and transmitter/receiver 460 (or “transceiver”). RIM 100 may be implemented as a single device that is able to be installed at legacy cash terminals 110 using existing connection features of such cash terminals 110 (e.g., cables, sockets, contacts, pins, and/or other connectors).

The terminal interface 410 may include various sockets, cables, contacts, pins, and/or other connectors or connection elements that may be able to interface with various components of a cash terminal 110. Such components may include controllers or processors, cash validation elements, dispensation elements including controllers and mechanical features, controllers or actuators associated with features such as gates or turnstiles, etc. The terminal interface 410 may further be able to couple to cash terminal 110 features or components such as a regulated power supply.

Processor 420 may execute instructions and/or otherwise process data. For instance, processor 420 may be able to perform calculations associated with verification of received cryptocurrency coins. As another example, processor 420 may be able to at least partly direct operations of cash terminal 110, such as dispensation of products, via terminal interface 410.

Memory 430 may store instructions and/or data. Such instructions may include, for instance, instruction related to cryptocurrency coin or digital certificate verification algorithms. Stored data may include data related to processed transactions (e.g., user device identifiers, username or account number, transaction amount, timestamp, etc.), stored or transferred cryptocurrency coins (or other representative data), item(s) purchased, deposit destination, etc.

UI 440 may include various indicators or features associated with operation of RIM 100. For instance, UI 440 may include one or more indicator lights (e.g., differently colored light emitting diodes (LEDs)) that may indicate status of the RIM 100 to a technician or other such user. As another example, UI 440 may include buttons, a keypad, touchscreen, or similar elements that may allow a technician to update price information, inventory information, etc.

Security module 450 may evaluate data associated with cryptocurrency transactions and determine whether any requested transactions should be authorized or performed. For instance, security module 450 may encrypt and/or decrypt data using one or more keys. As another example, security module 450 may be able to verify received cryptocurrency coin data to determine whether the coin is valid. Security module 450 may be able to evaluate received digital certificates and/or associated signatures to determine whether the data is valid. Security module 450 may be able to interact with various network resources via a user device 130 in order to update evaluation algorithms, keys or other data manipulation elements, validation criteria, etc.

Transmitter/receiver 460 may be able to interact with various user devices 130 and/or other devices via wireless connections in order to perform or otherwise facilitate various cash and/or cryptocurrency transactions. Transmitter/receiver 460 may, for instance, communicate across one or more channels such as a Bluetooth channel, a Wi-Fi connection, a cellular connection, etc.

Transmitter 460 may broadcast a beacon signal that may be received by user devices 130 within a broadcast range of the RIM 100, where such a range may be selectable or otherwise configurable. Such a beacon signal may include information such as a unique identifier associated with RIM 100. The beacon signal may be transmitted at regular intervals or based on some transmission criteria.

One of ordinary skill in the art will recognize that RIM 100 may be implemented in various different ways without departing from the scope of the disclosure. For instance, RIM 100 may include additional components such as a power module, a communication interface, etc.

FIG. 5 illustrates a schematic block diagram of a portion of a cash terminal 110 of one or more embodiments described herein. As shown, currency module 120 may include a cash module (or “cash processing module”) 510 and a payment module (or “payment processing module”) 520. Cash module 510 may be associated with various cash processing elements such as coin or bill validators. Payment module 520 may be associated with various dispensation or confirmation elements such as a vending machine release, parking receipt printer, etc. Received cash payments may be converted into electric or electronic signals by cash module 510 and such signals may be provided via an output interface 530 such as a cable connector, tab, slot, set of pins or contacts, etc. Payment module 520 may receive such signals via an input interface 540 such as a cable connector, tab, slot, set of pins or contacts, and/or other complementary feature to output interface 530. Output interface 530 and input interface 540 may be associated with a coupling 550 allowing data to be transferred between the cash module 510 and payment module 520. Coupling 550 may include various connectors, such as pins and sockets, wires, slots, tabs, contacts, etc.

Payment module 520 may include, or be associated with, a processor, controller, or other such element that may be able to evaluate signals received from cash module 510 and determine whether to provide access to products or services associated with the cash terminal 110 (e.g., by printing a parking receipt or activating a set of vending machine selection buttons).

FIG. 6 illustrates a schematic block diagram of a portion of an upgraded cash terminal 110 of one or more embodiments described herein. As shown, terminal interface 410 may be coupled to cash module 510 and payment module 520, where cash module 510 and payment module 520 are no longer coupled directly together. Terminal interface 410 may include a payment module emulator 610 and a cash module emulator 620.

Payment module emulator 610 may connect to cash module 510 and receive cash transaction information from the cash module 510. The payment module emulator 610 may generate confirmation signals or other appropriate signals (e.g., refund or dispense cash) that may cause cash module 510 to perform various operations or otherwise at least partly direct operations of the cash module 510.

Cash module emulator 620 may connect to payment module 520 and generate signals associated with receipt or dispensation of cash. Payment module 520 may receive such signals as if from the cash module 510, whether received payments are made in actual cash or via a cryptocurrency account or token.

Output interface 530 may be coupled to payment module emulator 610 via complementary emulator input interface 630 and associated coupling 640. Input interface 540 may be coupled to cash module emulator 620 via complementary output interface 650 and associated coupling 660.

Input interface 630 and output interface 650 may be configured such that RIM 100 is able to be installed between the cash module 510 and payment module 520 without requiring modifications (or with minimal modifications) to output interface 530 and input interface 540, such as by providing complementary connectors to existing hardware. Terminal interface 410 may include various types of connectors associated with various types of cash terminals 110. In some embodiments, terminal interface 410 may include multiple types of connectors to allow use with various types, manufacturers, or models of legacy cash terminals 110.

Although the various interfaces may be described above as “input” or “output” for simplicity, one of ordinary skill in the art will recognize that such interfaces may be used for two-way communications.

FIG. 7 illustrates a message flow diagram associated with various exemplary transactions performed by one or more embodiments described herein. Such transactions may be implemented by or via the terminal interface 410 described above.

In a first example, a cash payment is processed by a cash terminal 110 with no associated RIM 100. Cash module 510 transmits data 710 associated with receipt of bills or coins to payment module 520 for processing.

In a second example, a cash payment is processed by a cash terminal 110 with an associated RIM 100. Cash module 510 transmits data 720 associated with receipt of bills or coins to payment module emulator 610 for processing. Payment module emulator 610 may receive the data 720 and transmit received cash data 730 to the cash module emulator 620. Cash module emulator 620 may generate and transmit emulated cash module data 740 to the payment module 520, which may interpret the received data 740 in the same way as the data 710 received with no RIM 100.

In a third example, a digital payment is processed by RIM 100 and applied at cash terminal 110. As shown, cryptocurrency payment data 750 may be received at cash module emulator 620. Such payment data 750 may be generated based on selections made using a GUI such as GUI 300. The payment data may include validation information, amount, source, timestamp, etc. Cash module emulator 620 may receive the payment data and generate and transmit emulated cash module data 750 reflecting the received cryptocurrency payment (e.g., amount received) to the payment module 520, which may interpret the received data 760 in the same way as the data 710 received with no RIM 100 or data 740 based on a cash payment.

In a fourth example, a cash deposit is processed by a cash terminal 110 with an associated RIM 100. As shown, cash may be received at cash module 510 which generates an output data signal 770 associated with receipt of the cash and sends the output data signal 770 to the payment module emulator 610. The payment module emulator 610 may receive the deposited cash information and generate and send a deposit request 780 to a resource such as digital currency manager 140 or user device 130 for further processing.

FIG. 8 illustrates an example process 800 for implementing a digital wallet payment at a cash terminal. Such a process may allow use of cryptocurrency for payment at a cash terminal 110. The process may be performed when a cash terminal 110 is powered on and/or under other appropriate circumstances. In some embodiments, process 800 may be performed by RIM 100.

As shown, process 800 may include identifying (at 810) a proximate user device 130 and establishing (at 820) a connection to the user device 130. Proximate user devices may be identified (at 810) by transmitting a wireless beacon signal and receiving a response. The response may include identifying information related to the user device 130 (e.g., serial number or subscriber number) and/or associated user (e.g., username) and/or other appropriate information. A connection may be established (at 820) using various appropriate protocols (e.g., Bluetooth, Wi-Fi, etc.) utilizing components such as transmitter/receiver 460.

The process may include receiving (at 830) a payment request from the user device 130. As discussed above, the payment request may include a payment amount, information identifying a digital wallet or other digital accounts, cryptocurrency coins, and/or other digital representations of value, and/or other appropriate information. The payment request may be received via a wireless channel such as a Bluetooth link using a component such as transmitter/receiver 460.

As shown, process 800 may include determining (at 840) whether the payment request is valid. Such a determination may be made in various appropriate ways. For instance, security module 450 may analyze a received request and attempt to validate the authenticity of cryptocurrency information. As another example, a payment request may be sent to a resource such as a digital currency manager 140 for evaluation. In such cases, an element such as security module 450 may analyze a digital certificate or other representation of authenticity provided by the digital currency manager 140.

Process 800 may include emulating (at 850) a cash payment if the received payment request is determined to be valid. Such cash payment emulation may be performed by an element such as terminal interface 140 or cash module emulator 620. The transaction may be completed via selections made at the associated cash terminal 110 (e.g., by pushing a selection button associated with a soda vending machine), automated or default response (e.g., printing an access ticket or parking receipt after payment is completed), or use of fee-based access (e.g., by passing through a turnstile or gate associated with the cash terminal 110).

The process may include sending (at 860) a confirmation message to the user device 130. The confirmation message may be sent over the wireless connection established at 820. The confirmation message may include information such as payment amount, payment source, timestamp, purchase information (if available), and/or other appropriate information (e.g., RIM identifier, user device identifier, cryptocurrency data strings, digital certificates, etc.). The confirmation message, or similar information, may be sent to other resources as necessary to finalize the cryptocurrency transaction.

As shown, process 800 may include sending (at 870) a rejection message to the user device 130 if the payment is not able to be validated. Such a rejection message may include similar information to the confirmation message, such as attempted payment amount, selected source, timestamp, and/or other appropriate information (e.g., RIM identifier, user device identifier, cryptocurrency data strings, digital certificates, etc.).

Process 800 may include storing or updating information related to any accepted or denied cryptocurrency payment or purchase. Such information may include data related to received cash payments, cryptocurrency payments, cryptocurrency deposits or withdrawals, changes to inventory, etc. Such information may be updated for cash payment in some embodiments.

Stored information related to the cash terminal 110 may include, for instance, total cash housed by the terminal 110, value of cryptocurrency coins stored at RIM 100, inventory or availability of products or resources (e.g., numbers of each type of soda available, open parking spaces, etc.), and/or other appropriate information.

FIG. 9 illustrates an example process 900 for implementing a cash deposit to a digital wallet. Such a process may allow cash deposits at a cash terminal 110 to be applied to a cryptocurrency account. The process may be performed when a cash terminal 110 is powered on or under other appropriate circumstances. In some embodiments, process 900 may be performed by RIM 100.

As shown, process 900 may include identifying (at 910) a proximate user device 130 and establishing (at 920) a connection to the user device 130. Proximate user devices may be identified (at 910) by transmitting a wireless beacon signal and receiving a response. The response may include identifying information related to the user device 130 (e.g., serial number or subscriber number) and/or associated user (e.g., username) and/or other appropriate information. A connection may be established (at 920) using various appropriate protocols (e.g., Bluetooth, Wi-Fi, etc.).

The process may include receiving (at 930) deposit information from the cash terminal 110. Such deposit information may be received at the RIM 100 via a resource such as terminal interface 140 or payment module emulator 610 from a component of cash terminal 110, such as cash module 510. The received deposit information may include information such as total amount of cash deposited. Received deposit information may include, if available, captured data such as image scans of bills or notes.

As shown, process 900 may include sending (at 940) deposit information to the user device. Deposit information may include the amount of cash available for deposit, cryptocurrency coins or data for deposit, and/or other appropriate information.

Process 900 may include receiving (at 950) a validation message or a rejection message at the RIM 100 from the user device 130. Such a message may include a digital deposit receipt, an amount, account information, cryptocurrency coin information, and/or other information associated with a successful or unsuccessful deposit.

The process may include sending (at 960) a confirmation to the cash terminal 110. Such a confirmation may include different elements or information depending on the attributes of a particular transaction. The confirmation may be provided to a resource such as cash module 510 by a resource such as terminal interface 510 or payment module emulator 610. In some cases, a resource such as cash module 510 may securely store any received cash unless a refund or similar message is received.

As shown, process 900 may include storing (at 970) and/or updating stored cash terminal data. Such data may include data related to received cash payments, cryptocurrency payments, cryptocurrency deposits or withdrawals, changes to inventory, and/or other appropriate information.

FIG. 10 illustrates an example process 1000 for implementing a digital wallet payment at a cash terminal via a user device. Such a process may allow use of cryptocurrency for payment at a cash terminal 110. The process may be implemented via a user device application, web resource, or other appropriate resources. The process may be performed when a beacon signal is received from a RIM 100 or under other appropriate circumstances. In some embodiments, process 1000 may be performed by user device 130.

As shown, process 1000 may include identifying (at 1010) a proximate RIM 100 and establishing (at 1020) a connection to the RIM 100. As discussed above, RIM 100 may broadcast a beacon signal that is able to be received by user devices 130 within a transmission range of the RIM 100. The user device 130 may execute an installed application or other resource that is able to response to the beacon signal and establish a communication channel, such as a Bluetooth link, between the user device 130 and the RIM 100.

The process may include sending (at 1030) a payment request to a digital currency manager 140 or other appropriate resource. Alternatively, some embodiments may process such requests at the user device without use of a digital currency manager 140 or other external resource. The payment request may include information such as RIM identifier, user device identifier, requested amount, payment source, timestamp, etc.

As shown, process 1000 may include receiving (at 1040) a validation message from the digital currency manager. Alternatively, the request may be validated at the user device 130 if no digital currency manager 140 is used.

Process 1000 may include determining (at 1050) if the payment request is valid. Such a determination may be made by evaluating the response from the digital currency manager 140. For instance, security module 450 may determine whether a digital certificate received from the digital currency manager 140 is valid.

The process may include sending (at 1060) a validation message to the RIM 100 if the process determines (at 1050) that the payment request is valid. The validation message may include information such as RIM identifier, a digital certificate, blockchain string, payment amount, payment source, etc.

As shown, process 1000 may include sending (at 1070) a rejection message to the RIM 100 indicating that the payment request was not able to be validated if the process determines (at 1050) that the payment request is not valid. Such a rejection message may include information such as RIM identifier, a requested amount, selected source, reason for rejection, and/or other appropriate information.

Process 1000 may include storing (at 1080) transaction information. Such stored information may include, for instance, RIM identifier, payment amount, selected source, and/or other appropriate information.

FIG. 11 illustrates an example process 1100 for implementing a cash deposit from a cash terminal to a digital wallet via a user device. Such a process may allow cash deposits at a cash terminal 110 to be applied to a cryptocurrency account. The process may be implemented via a user device application, web resource, or other appropriate resources. The process may be performed when a beacon signal is received from a RIM 100 or under other appropriate circumstances. In some embodiments, process 1100 may be performed by user device 130.

As shown, process 1100 may include identifying (at 1110) a proximate RIM 100 and establishing (at 1120) a connection to the RIM 100. As discussed above, RIM 100 may broadcast a beacon signal that is able to be received by user devices 130 within a transmission range of the RIM 100. The user device 130 may execute an installed application or other resource that is able to response to the beacon signal and establish a communication channel, such as a Bluetooth link, between the user device 130 and the RIM 100.

The process may include receiving (at 1130) deposit information from the RIM 100. Such deposit information may include an amount, such as the amount of cash received at the cash terminal 110 associated with the RIM 100.

As shown, process 1100 may include sending (at 1140) deposit information to a digital currency manager 140 or other appropriate resource. Such deposit information may include, for instance, an amount, destination account or wallet, RIM identifier, and/or other appropriate information. Alternatively, some embodiments may process deposit information locally at the user device 130 (e.g., by storing cryptocurrency coins received from the RIM 100).

Process 1100 may include receiving (at 1150) a validation message from the digital currency manager. Alternatively, the transaction information may be validated locally at the user device 130 in some embodiments. The validation message may include a digital certificate or other representation of authenticity.

The process may include determining (at 1160) whether the deposit is valid. Such a determination may be made based on, for instance, analysis of cryptocurrency data strings or digital certificate information associated with a deposit request.

As shown, process 1100 may include sending (at 1170) a validation message to the RIM 100 if the deposit request is determined (at 1160) to be valid. Such a validation message may include, for instance, an amount, confirmation code, digital certificate information, cryptocurrency coin information, and/or other appropriate information. Receipt of such a validation message may cause RIM 100 to update information related to stored cash, cryptocurrency, etc.

Process 1100 may include sending (at 1180) a rejection message to the RIM 100. Such a message may include a reason or code identifying the reason for rejection. Such a rejection may cause RIM 100 to direct an element such as cash module 510 to return cash that was not able to be deposited.

The process may include storing (at 1190) transaction information related to the requested deposit. Such information may include, for instance, RIM identifier, whether the request was validated or rejected, a deposit amount, deposit destination, and/or other appropriate information.

FIG. 12 illustrates an example process 1200 for implementing a digital wallet payment at a cash terminal via a digital currency manager. Such a process may allow use of cryptocurrency for payment at a cash terminal 110. The process may be performed when a connection request is received from a user device 130 or under other appropriate circumstances. In some embodiments, process 1200 may be performed by digital currency manager 140.

As shown, process 1200 may include establishing (at 1210) a connection to a user device 130. Such a connection may be established using various appropriate messaging or other communication protocols. Such messages may be sent across one or more networks.

Process 1200 may include receiving (at 1220) a payment request from the user device 130. The payment request may include information such as RIM identifier, user device identifier, requested amount, payment source, cryptocurrency string, timestamp, etc.

The process may include analyzing, authenticating, and validating (at 1230) the received payment request. Such analysis may include evaluation of cryptocurrency blockchain data, confirmation of account credentials (e.g., account number, username, password, etc.), account balances, analysis of other requests associated with the RIM 100, and/or other appropriate evaluation.

As shown, process 1200 may include determining (at 1240) whether the received payment request is valid. The determination may be based on the analysis performed at 1230.

Process 1200 may include sending (at 1250) a validation message to the user device 130 if the process determines (at 1240) that the request is valid. Such a validation message may include, for instance, a payment amount, confirmation code, RIM identifier, user device identifier, digital certificate information, cryptocurrency coin information, and/or other appropriate information.

The process may include sending (at 1260) a rejection message to the user device 130 if the request is determined (at 1240) to be invalid. Such a rejection message may include information identifying the type of rejection or offering ways to rectify the rejection (e.g., by specifying that a payment request exceeds an available balance).

As shown, process 1200 may include storing (at 1270) transaction information. Such transaction information may include, for instance, RIM identifier, whether the payment request was validated or rejected, a payment amount, payment source, and/or other appropriate information.

FIG. 13 illustrates an example process 1300 for implementing a cash deposit from a cash terminal to a digital wallet via a digital currency manager. Such a process may allow cash deposits at a cash terminal 110 to be applied to a cryptocurrency account. The process may be performed when a connection request is received from a user device 130 or under other appropriate circumstances. In some embodiments, process 1300 may be performed by digital currency manager 140.

As shown, process 1300 may include establishing (at 1310) a connection to a user device 130. Such a connection may be established using various appropriate messaging or other communication protocols. Such messages may be sent across one or more networks.

Process 1300 may include receiving (at 1320) a deposit request from a user device 130. Such a deposit request may include information such as, for instance, RIM identifier, user device identifier, deposit amount, destination, cryptocurrency strings, and/or other appropriate information.

The process may include analyzing, authenticating, and validating (at 1330) the received deposit request. Such analysis may include evaluation of cryptocurrency blockchain data, confirmation of account credentials (e.g., account number, username, password, etc.), analysis of other requests associated with the RIM 100, and/or other appropriate evaluation.

As shown, process 1300 may include determining (at 1340) whether the deposit request is valid. Such a determination may be made based on the analysis performed at 1330.

Process 1300 may include sending (at 1350) a validation message to the user device 130 if the deposit request is determined (at 1340) to be valid.

The process may include sending (at 1360) a rejection message to the user device 130 if the deposit request is determined (at 1340) to be invalid.

As shown, process 1300 may include storing (at 1370) transaction information. Such transaction information may include, for instance, RIM identifier, whether the deposit request was validated or rejected, a deposit amount, destination account, and/or other appropriate information.

One of ordinary skill in the art will recognize that processes 800-1300 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

FIG. 14 illustrates a schematic block diagram of an exemplary device (or system or devices) 1400 used to implement some embodiments. For example, the systems, devices, and/or components described above in reference to FIG. 1, FIG. 2, FIG. 3, FIG. 4, FIG. 5, FIG. 6, and FIG. 7 may be at least partially implemented using device 1400. As still another example, the processes described in reference to FIG. 8, FIG. 9, FIG. 10, FIG. 11, FIG. 12, and FIG. 13 may be at least partially implemented using device 1400.

Device 1400 may be implemented using various appropriate elements and/or sub-devices. For instance, device 1400 may be implemented using one or more personal computers (PCs), servers, mobile devices (e.g., smartphones), tablet devices, wearable devices, and/or any other appropriate devices. The various devices may work alone (e.g., device 1400 may be implemented as a single smartphone) or in conjunction (e.g., some components of the device 1400 may be provided by a mobile device while other components are provided by a server).

As shown, device 1400 may include at least one communication bus 1410, one or more processors 1420, memory 1430, input components 1440, output components 1450, and one or more communication interfaces 1460.

Bus 1410 may include various communication pathways that allow communication among the components of device 1400. Processor 1420 may include a processor, microprocessor, microcontroller, digital signal processor, logic circuitry, and/or other appropriate processing components that may be able to interpret and execute instructions and/or otherwise manipulate data. Memory 1430 may include dynamic and/or non-volatile memory structures and/or devices that may store data and/or instructions for use by other components of device 1400. Such a memory device 1430 may include space within a single physical memory device or spread across multiple physical memory devices.

Input components 1440 may include elements that allow a user to communicate information to the computer system and/or manipulate various operations of the system. The input components may include keyboards, cursor control devices, audio input devices and/or video input devices, touchscreens, motion sensors, etc. Output components 1450 may include displays, touchscreens, audio elements such as speakers, indicators such as light-emitting diodes (LEDs), printers, haptic or other sensory elements, etc. Some or all of the input and/or output components may be wirelessly or optically connected to the device 1400.

Device 1400 may include one or more communication interfaces 1460 that are able to connect to one or more networks 1470 or other communication pathways. For example, device 1400 may be coupled to a web server on the Internet such that a web browser executing on device 1400 may interact with the web server as a user interacts with an interface that operates in the web browser. Device 1400 may be able to access one or more remote storages 1480 and one or more external components 1490 through the communication interface 1460 and network 1470. The communication interface(s) 1460 may include one or more application programming interfaces (APIs) that may allow the device 1400 to access remote systems and/or storages and also may allow remote systems and/or storages to access device 1400 (or elements thereof).

It should be recognized by one of ordinary skill in the art that any or all of the components of computer system 1400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1400 may perform various operations in response to processor 1420 executing software instructions stored in a computer-readable medium, such as memory 1430. Such operations may include manipulations of the output components 1450 (e.g., display of information, haptic feedback, audio outputs, etc.), communication interface 1460 (e.g., establishing a communication channel with another device or component, sending and/or receiving sets of messages, etc.), and/or other components of device 1400.

The software instructions may be read into memory 1430 from another computer-readable medium or from another device. The software instructions stored in memory 1430 may cause processor 1420 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

I claim:

1. A device, comprising:
one or more processors configured to:
identify, at a retrofit interface module (RIM) associated with a cash terminal, a proximate user device;
establish a wireless communication link between the RIM and the proximate user device;
receive a payment request from the proximate user device;
evaluate the payment request to determine if the payment request is valid; and
emulate a cash payment to the cash terminal if the payment request is determined to be valid or generate a request rejection if the payment request is determined to be invalid.

2. The device of claim 1, wherein identifying a proximate user device comprises:
broadcasting a beacon signal; and
receiving a response to the beacon signal from the proximate user device.

3. The device of claim 1, wherein emulating the cash payment to the cash terminal comprises generating a matching set of signals to those generated by a cash processing module of the cash terminal when a payment amount associated with the payment request is deposited using physical currency.

4. The device of claim 1, wherein evaluating the payment request comprises analyzing at least one blockchain string associated with at least one cryptocurrency coin.

5. The device of claim 1, wherein the payment request comprises a payment amount and a payment source.

6. The device of claim 5, wherein the payment source comprises at least one of a cryptocurrency coin data string or a digital wallet account identifier.

7. The device of claim 1, wherein the payment request comprises a digitally signed certificate.

8. A device, comprising:
one or more processors configured to:
identify, at a retrofit interface module (RIM) associated with a cash terminal, a proximate user device;
establish a wireless communication link between the RIM and the proximate user device;
receive, from the cash terminal, a cash deposit amount;
send, to the proximate user device, cash deposit information including the cash deposit amount; and
receive a validation message indicating receipt of the cash deposit information.

9. The device of claim 8, wherein identifying a proximate user device comprises:
broadcasting a beacon signal; and
receiving a response to the beacon signal from the proximate user device.

10. The device of claim 8, wherein the validation message further comprises at least one of a cryptocurrency coin data string or a digital wallet account identifier.

11. The device of claim 8, wherein the cash deposit information comprises a cryptocurrency coin data string.

12. The device of claim 8, wherein the cash terminal comprises a cash processing module including at least one of a bill validator or a coin validator and wherein receiving the cash deposit amount comprises calculating, based on signals received from the cash processing module at the RIM, an amount of cash deposited to the bill validator or coin validator.

13. The device of claim 8, wherein the validation message comprises at least one of a cryptocurrency coin data string or a digital wallet account identifier.

14. The device of claim 8, wherein the validation message comprises a digitally signed certificate.

15. A method comprising:
identifying, at a retrofit interface module (RIM) associated with a cash terminal, a proximate user device;
establishing a wireless communication link between the RIM and the proximate user device;
receiving a payment request from the proximate user device;
evaluating the payment request to determine if the payment request is valid; and
emulating a cash payment to the cash terminal if the payment request is determined to be valid or generating a request rejection if the payment request is determined to be invalid.

16. The method of claim 15, wherein identifying a proximate user device comprises:
broadcasting a beacon signal; and
receiving a response to the beacon signal from the proximate user device.

17. The method of claim 15, wherein emulating the cash payment to the cash terminal comprises generating a matching set of signals to those generated by a cash processing module of the cash terminal when a payment amount associated with the payment request is deposited using physical currency.

18. The method of claim 15, wherein evaluating the payment request comprises analyzing at least one blockchain string associated with at least one cryptocurrency coin.

19. The method of claim 15, wherein the payment request comprises a payment amount and a payment source, wherein the payment source comprises at least one of a cryptocurrency coin data string or a digital wallet account identifier.

20. The method of claim 15, wherein the payment request comprises a digitally signed certificate.
